(19) United States
(12) Patent Application Publication
(10) Pub. No.: US 2005/0005867 A1
(43) Pub. Date: Jan. 13, 2005

(54) Island ant guard pet feeding dish

(76) Inventor: HipoLito Hernandez, Sun Valley, CA (US)

Correspondence Address: HipoLito Hernandez, 9381 ILEX Ave., Sun Valley, CA, 91352, US

(21) Appl. No.: 10/750,614

(22) Filed: Sep. 23, 2004

Related U.S. Application Data
(60) Provisional application No. 60/437,877, filed on Jan. 6, 2003.

(51) Int. Cl. A01K 5/01

(52) U.S. Cl. 119/61.5

(57) ABSTRACT

The “Island Ant Guard Pet Feeding Dish” was designed to keep ants and other creeping bugs out of pets food by utilizing a border of water, the same as a moat was used in previous times to keep out invaders. The water is placed in a small trench encircling the feeding dish and covered with an extended lip to prevent the pets from drinking it, and also to prevent food from falling into the water, thus eliminating a potential bridge for the ants to reach the food.

I, Hipolito Hernandez, have invented a new design for a pet-feeding dish. It is called the “Island Ant-Guard Pet Feeding Dish,” as set forth, in the following specifications. The most important features are the water border and the extended lip overlapping the trench holding the water.

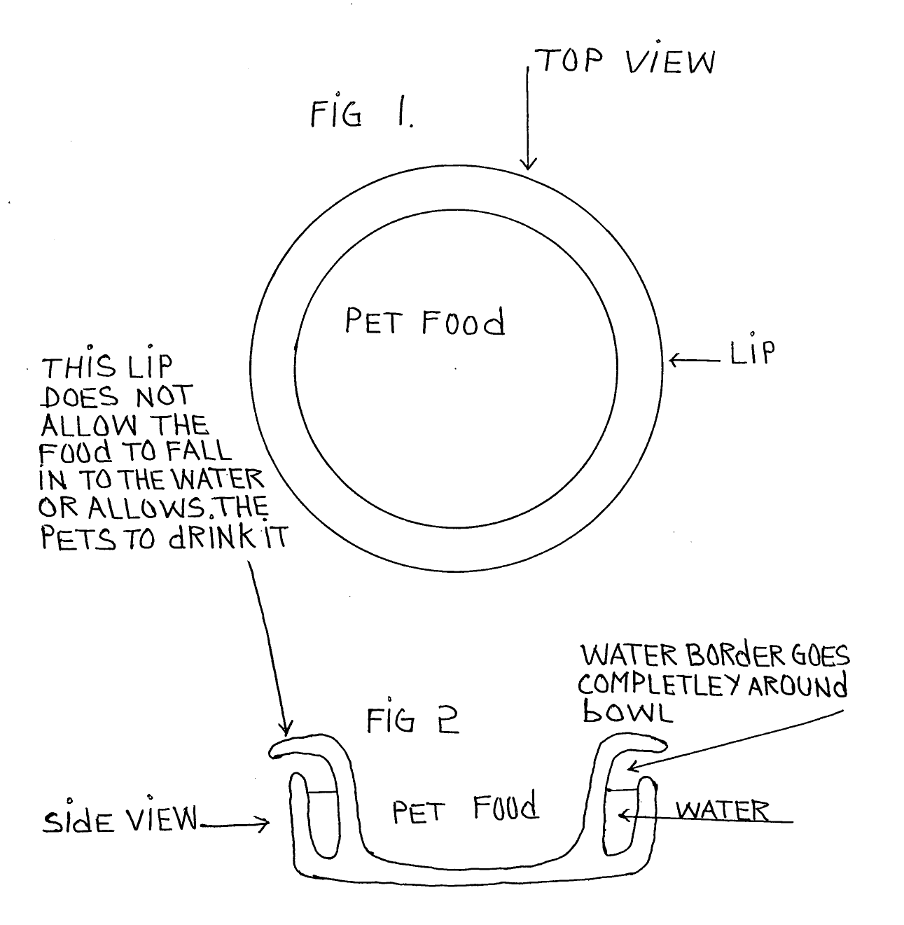

FIG. 1 Is a top view of the feeding dish where the food sits along with the extended lip protecting the water border below.

FIG. 2 Is a side view of feeding dish, featuring the overhanging lip, along with where the water sits as a border against unwanted ants.

1. I, Hipolito Hernandez, hereby claim the “Island Pet Guard Feeding Dish,” as my invention. It consists of a circular bowl ringed by a trench to hold water in a bid to keep out ants. Covering the trench is an extended lip to prevent pets from drinking the water, and also to keep the food from falling into said trench. I hereby state that I am the sole inventor of this new concept utilizing a water border.
